(19) United States
(12) Patent Application Publication
(10) Pub. No.: US 2005/0214415 A1
(43) Pub. Date: Sep. 29, 2005

(54) Ladle

(75) Inventors: Todd W. Craig, Frisco, TX (US); Peter G. Graham, Lucas, TX (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: PIZZA HUT, INC.

(21) Appl. No.: 11/109,486

(22) Filed: Apr. 19, 2005

Related U.S. Application Data
(63) Continuation-in-part of application No. 29/199,098, filed on Feb. 10, 2004, now Pat. No. D504056.
(63) Continuation-in-part of application No. 10/775,753, filed on Feb. 10, 2004.
(60) Provisional application No. 60/592,033, filed on Jul. 28, 2004.

(51) Int. Cl. A23G 3/00

(52) U.S. Cl. 426/94

(57) ABSTRACT

A method of distributing fluid material on a food item includes providing a spreader having a shape substantially corresponding to the shape of the food item, and using the spreader to spread the fluid material evenly on the food item, edges of the spread fluid material being substantially parallel with and substantially evenly spaced from edges of the food item, the using occurring free of twisting, turning or rotation of the spreader or the food item. A spreader for spreading fluid material on a food item includes a handle and a bowl having a shape substantially corresponding to a shape of the food item.

### CROSS-REFERENCE TO RELATED APPLICATIONS

This application claims the benefit of U.S. Provisional Patent Application No. 60/592,033, filed Jul. 28, 2004, priority to which is claimed under 35 U.S.C. §119(e) and which is incorporated herein by reference; this application is also a continuation-in-part of U.S. Design Patent Application No. 29/199,098, filed Feb. 10, 2004, now U.S. Pat. No. D504,056, issued Apr. 19, 2005, and which is incorporated herein by reference; this application is also a continuation-in-part of U.S. patent application Ser. No. 10/775,753, filed Feb. 10, 2004, which is incorporated herein by reference.

### BACKGROUND OF THE INVENTION

Pizza is one of the most popular food items in the United States. Pizzas come in many different shapes and sizes, with virtually unlimited variation in the types of toppings, meats, vegetables, cheese, doughs/crusts and other ingredients used. Pizza makers select and assemble these ingredients to create a taste, aroma, texture and consistency in accordance with the desires of their selected audience. Commercial pizza makers with national and international presence, especially pizza restaurants, typically select, develop and promote a number of different pizzas, varying at least in the number and type of toppings.

So that one or more consumers can enjoy different styles or types of pizzas in one sitting, it is often desired to provide pizzas made-to-order in one way on one portion of the pizza, and in another way on another portion of the pizza. A customer or group customers in a pizza restaurant, for example, might order one topping on one-half of the pizza and another topping on another half of the pizza. Potential difficulties arise, however, in that different topping types may not be distributed or maintained exactly as desired. For example, one topping type intended for one portion of the pizza may spill over to the other portion of the pizza when the pizza is made, or toppings may slide off their intended portion of the pizza when the pizza is cut. Additionally, pizza may not be cut exactly at the division line between the differently prepared portions. It can also be operationally difficult to combine certain pizza variations into a single pizza.

Accordingly, an apparatus for holding and preparing multiple pizzas from a single or multiple sheets of dough has been developed. See, for example, U.S. patent application Ser. No. 10/775,753, filed Feb. 10, 2004, priority to which is claimed under 35 U.S.C. §120 and which is incorporated herein by reference. Pizza sauce is applied to each of the multiple pizzas, by a utensil such as a spreader or ladle.

### SUMMARY OF THE INVENTION

A method of distributing fluid material on a food item includes providing a spreader having a shape substantially corresponding to the shape of the food item, and using the spreader to spread the fluid material evenly on the food item, edges of the spread fluid material being substantially parallel with and substantially evenly spaced from edges of the food item, the using occurring free of twisting, turning or rotation of the spreader or the food item. A spreader for spreading fluid material on a food item includes a handle and a bowl having a shape substantially corresponding to a shape of the food item.

### BRIEF DESCRIPTION OF THE DRAWINGS

Embodiments of the invention are described with respect to the figures, in which like reference numbers denote like elements and in which:

FIG. 1 is a perspective view of a ladle according to an embodiment of the invention.

FIG. 2 is a side view of a ladle according to an embodiment of the invention. Another side view is an identical mirror image of FIG. 2 and is omitted.

FIG. 3 is a front view of a ladle according to an embodiment of the invention.

FIG. 4 is a back view of a ladle according to an embodiment of the invention.

FIG. 5 is a top view of a ladle according to an embodiment of the invention.

FIG. 6 is a bottom view of a ladle according to an embodiment of the invention.

FIG. 7 is a perspective view showing a saucing process, according to an embodiment of the invention.

FIG. 8 is a perspective view showing nested ladle portions, according to an embodiment of the invention.

### DETAILED DESCRIPTION

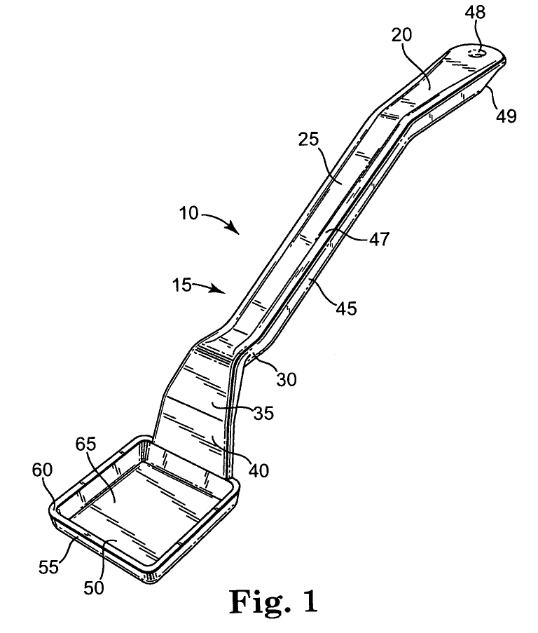

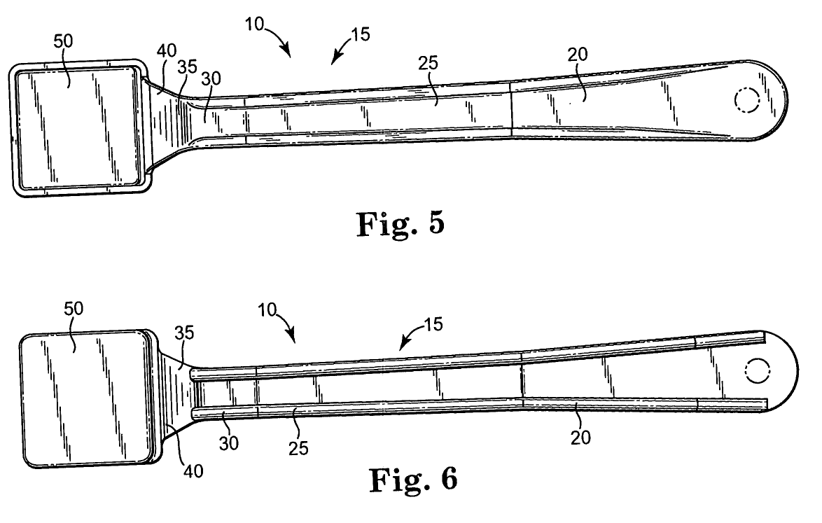

FIGS. 1-6 illustrate ladle 10 according to an embodiment of the invention. Ladle 10 includes handle 15. Handle 15 includes end portion 20, intermediate portion 25, extension portion 30, first downwardly depending portion 35, and second downwardly depending portion 40. Edge 45 extends along one or more of portions 20, 25, 30, 35 and 40 and provides structural rigidity to handle 15. Taper or bevel 47 joins edge 45 to one or more of the remainder of the handle portions. Aperture 48 allows ladle 10 to be suspended from a peg, hook, hanger or other hanging device. Edge 45 defines a ramped or angled portion 49 at the outer end thereof, such that portion 20 is thinner in a vertical dimension (as viewed in e.g. FIG. 1) at the aperture end thereof than at the end thereof adjoining portion 25. At the same time, portion 20 substantially widens toward the aperture end thereof in a dimension substantially perpendicular to the substantially vertical dimension, e.g. to provide a gripping surface of increased surface area.

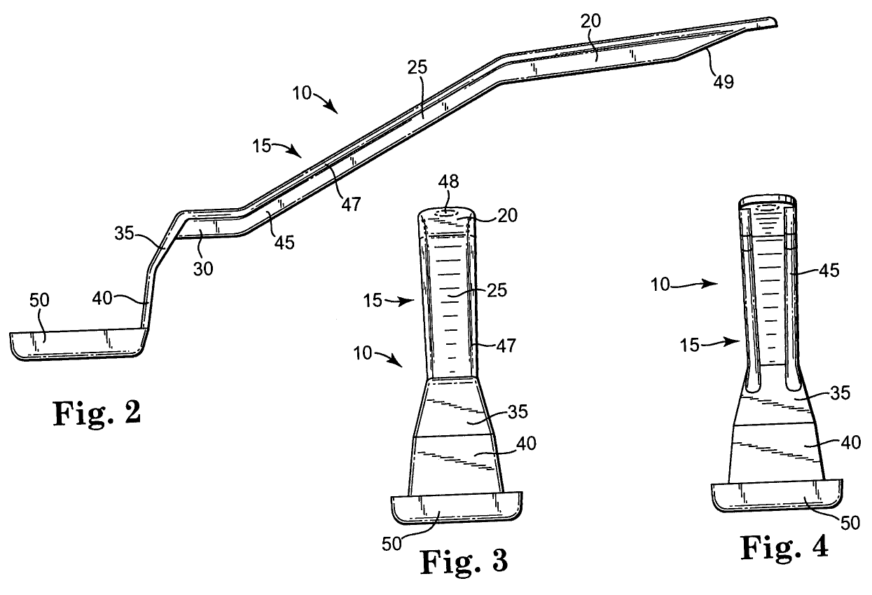

Handle 15 defines different angles between portions 20, 25, 30, 35 and 40. The angles between, and relative lengths and dimensions of, the portions of handle 15 illustrated in FIG. 2 are to be considered as to-scale, according to one embodiment, and as forming a portion of this description. The lengths and angles of the handle portions optionally are selected such that, in use, ladle 10 extends downwardly from the hand of a user into a pan or other container or utensil with sufficient reach and depth. Portion 35 is tapered outwardly with respect to portion 30 for intersection with portion 40, i.e. portion 35 is wider at the edge of portion 40 than it is at the edge of portion 30. Portion 40 is tapered outwardly with respect to portion 35 for intersection with bowl 50, i.e. portion 40 is wider at the edge of bowl 50 than at the edge of portion 35.

Bowl 50 is substantially square-shaped, according to the illustrated embodiment, and includes four upstanding sidewalls 55, four substantially rounded corners 60, and bottom 65. Bowl 50 is intended to deposit and then spread pizza sauce evenly to four corners of substantially square-shaped pizza dough portions, or other substantially square-shaped food items. According to embodiments of the invention, then, the shape of bowl 50 substantially corresponds to the shape of the food item to which ladle 10 is to apply and/or spread a liquid or fluid material such as pizza sauce. As will be described, however, embodiments of the invention are by no means limited to square-shaped bowls, or square-shaped pizza dough portions or food items.

Ladle 10, including the relative dimensions of and angular relationships between the portions of handle 15 described above, is adapted to spread sauce toward, to, and/or into the corners of e.g. a substantially square piece of pizza dough or other food item with corners, without twisting and turning the pan, and without twisting and turning ladle 10. Ladle 10 also is adapted for carrying pizza sauce or other material to the pizza dough or other food item and for depositing the sauce or material thereon. Ladle 10 is simply moved toward the four corners of a substantially square or substantially rectangular pizza dough or other food item, for example, to spread the pizza sauce or other material evenly over the entire pizza dough or other food item, and/or into the corners thereof, without applying the material undesirably to an edge of the food item, e.g. to and onto the outer crust of pizza dough.

Embodiments of the invention thus broadly relate to a utensil that is adapted to (1) carry or otherwise transport fluid material to a food item, such as pizza sauce to pizza dough, (2) deposit the material on the food item, and (3) spread the material on the food item substantially without having to twist and turn the utensil, the food item, or a container in which the food item is supported. By way of contrast, if a typical rounded-bowl ladle were used, it would be more difficult for a user to use the rounded edge of the bowl to evenly and accurately spread pizza sauce into a corner of pizza dough, without turning the ladle on edge or otherwise manipulating ladle or the food item in an awkward or undesirable manner, for example by twisting, turning and/or rotation.

Other bowl shapes and other food-item shapes are contemplated. For example, for substantially triangle-shaped pizza dough portions or other substantially triangle-shaped food items, a ladle with a substantially triangle-shaped bowl is advantageous for reaching into corners of the substantially triangle-shaped food item, again without undesirable twisting, turning, and/or rotation. According to one embodiment, a base of the triangle-shaped bowl is substantially centered on handle portion 40, and an apex of the bowl is disposed substantially opposite the base. Other bowl shapes and food-item shapes are contemplated, and are not limited to shapes having corners or straight edges.

In the illustrated square-shaped embodiment and in other-shape embodiments, edge(s) 55 of bowl 50 are substantially parallel to or otherwise substantially correspond to edges of the food item, and corners 60 of ladle 10 to corners of the food item. Accordingly, the edge of a portion of sauce or other material, once spread with ladle 15, will also be substantially parallel to or otherwise substantially correspond to corners 60 of ladle 10. Additionally, bowl 50 is of such dimensions that an amount of sauce or other material to be deposited on the food item is the same as or corresponds to the volume of bowl 50, or some even multiple of the volume of bowl 50. For example, one “scoop” or two “scoops” of pizza sauce effectively carried by bowl 50 of ladle 10 is just enough to evenly and adequately cover the pizza dough on which the sauce is being deposited and spread.

According to one embodiment, the sauce to be deposited and spread is relatively thick, and is shaken and/or scraped and/or gently thrown or flung from ladle 10 onto the pizza dough or other food item. The bottom of bowl 50 of ladle 10 then is used to spread the sauce evenly over the pizza dough and into the corners thereof. Thus, ladle 10 is adapted more for spreading operations than for pouring operations, according to certain specific embodiments of the invention, although pouring also is contemplated.

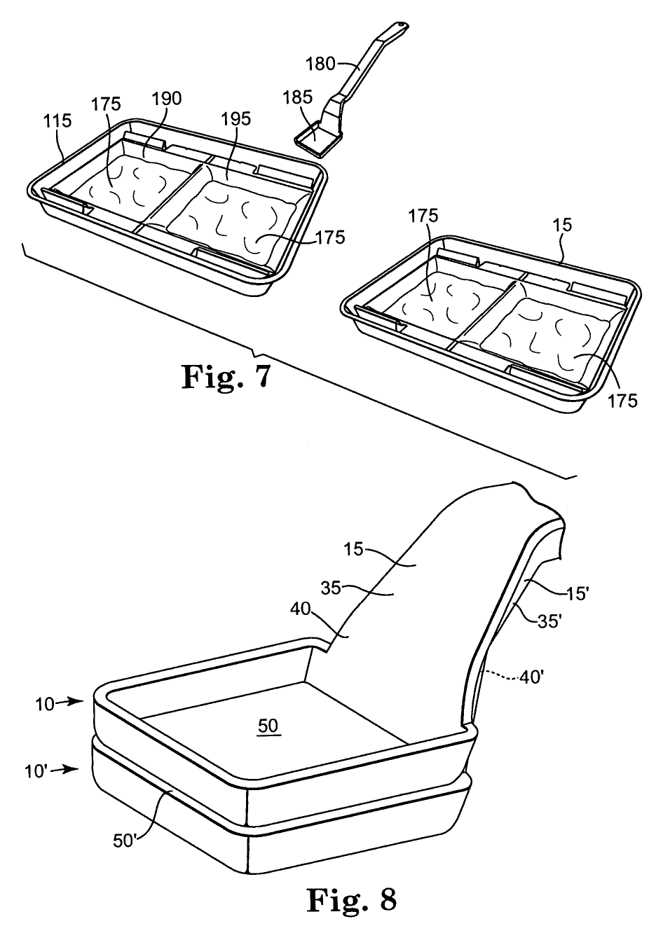

With reference to FIG. 7, a method according to embodiments of the invention includes placing ingredients on multiple dough portions 160, 165, supported by one or more pans 115, to form multiple pizzas, for example four pizzas. Such ingredients optionally include pizza sauce 175. Sauce 175 optionally is applied by ladle or spreader 180. Spreader 180 has bowl portion 185 substantially corresponding to the shape of dough portions 160, 165 and/or to the shape of pan 115 or portions of pan 115. According to the illustrated example, bowl portion 185 is substantially square-shaped, corresponding to substantially square-shaped support portions 190, 195 of pan 115 and/or dough portions 160, 165. Each corner of bowl portion 185 is pushed or moved to a corresponding corner of each dough portion 160, 165, to spread sauce across substantially the entire bottom of dough portions 160, 165, including into the corners thereof, without having to turn or lift spreader 180.

The ingredients placed on multiple dough portions 160, 165 also optionally include bottom cheese, meats, vegetables/fruits, top cheese, or any other food items or toppings suitable for placement on pizza products. Meats adapted for use optionally include pepperoni, sausage, ham, and/or bacon, to name several examples, and vegetables/fruits optionally include green peppers, mushrooms, black olives, and/or tomatoes, to name several examples. The placing of ingredients according to a method embodiment of the invention includes placing different types and/or combinations of ingredients on multiple dough portions 160, 165 such that multiple pizzas of different kinds are created. Embodiments of the invention extend to pizzas created by methods using ladle 10.

FIG. 8 illustrates portions of two ladles 10, 10′ in a nested configuration. Bowls 50, 50′ and the various portions of handles 15, 15′ described earlier herein, for example portions 35, 35′ and 40, 40′, are adapted to fit together, nest or otherwise correspond from top to bottom, as illustrated, for more compact storage, for example.

Those of ordinary skill in the art will appreciate that a wide variety of dimensions, relative angles, and other shape features are contemplated for ladle or spreader 10. For example, angles between portions 20, 25, 30, 35 and 40 of handle 15 and between portion 40 and bowl 50 are, respectively, as taken along a lower outside edge of ladle 10 as viewed in FIG. 2, which should be considered a to-scale drawing of one embodiment of the invention. Angles with a range of about 5 degrees to 15 degrees also are contemplated, and optionally are chosen in connection with the type of pan or other container into which ladle 10 is to be extended or lowered to perform saucing operations. Various materials are also contemplated for construction of ladle 10, for example injection-molded plastic, metal, polymer or other material known to those of ordinary skill in the art upon reading this disclosure.

U.S. patent application Ser. No. 10/775,753, filed Feb. 10, 2004, priority to which is claimed under 35 U.S.C. §120, discloses an apparatus for holding and preparing multiple pizzas. According to one embodiment, a single dough sheet settles into different portions of the apparatus and is upturned and angled in a manner to provide a “separate-pizza” appearance, i.e. to create an appearance of multiple, separately prepared pizzas in the finished, baked product. Embodiments of the present invention are especially, though not exclusively, applicable to applying pizza sauce to such multiple pizzas.

Embodiments of the invention are specifically directed toward pizza-type food products. Embodiments of the invention have wide application for use in cooking and preparing other foods and food products, however, including pies, cookies, pastries, etc. Thus while certain embodiments have been described with respect to pizza, the invention is not limited to those embodiments. Additionally, those of ordinary skill will appreciate that the invention contemplates a large number of variations and modifications beyond those specifically disclosed herein, including but not limited to additional dimensions, materials, shapes, and other features not specifically described herein.

1. A method of saucing pizza dough, the method comprising:
placing sauce on a central portion of the pizza dough, the pizza dough having a substantially square shape with four corners; and
spreading sauce into the four corners of the pizza dough using a ladle having a substantially square-shaped bowl, the spreading occurring free of twisting or turning the ladle, such that the sauce is distributed evenly into the corners of the pizza dough.

2. The method of claim 1, wherein the spread sauce forms edges substantially parallel to edges of the pizza dough.

3. The method of claim 1, wherein the spread sauce forms edges substantially parallel to edges of the ladle.

4. The method of claim 1, wherein the spreading comprises spreading sauce into four corners of each of two pieces of pizza dough supported by a common pan.

5. The method of claim 1, wherein the spreading includes using a bottom of the bowl to spread the sauce to the four corners of the pizza dough.

6. A method of distributing fluid material on a food item, the method comprising:
providing a spreader having a shape substantially corresponding to the shape of the food item; and
using the spreader to spread the fluid material evenly on the food item, edges of the spread fluid material being substantially parallel with and substantially evenly spaced from edges of the food item, the using occurring free of twisting, turning or rotation of the spreader or the food item.

7. The method of claim 6, wherein the using occurs solely with linear movements of the spreader with respect to the food item.

8. The method of claim 6, wherein the food item comprises pizza dough and the fluid material comprises pizza sauce.

9. The method of claim 6, wherein the spreader shape is substantially square and the food item shape is substantially square.

10. The method of claim 6, wherein the spreader shape is substantially triangular and the food item shape is substantially triangular.

11. The method of claim 6, further comprising using the spreader to deposit the fluid material onto the food item.

12. The method of claim 11, wherein the using the spreader to deposit comprises depositing pizza sauce onto a central portion of pizza dough.

13. A pizza or multiple pizzas produced by the method of claim 6.

14. A ladle, comprising:
a handle; and
a bowl having a substantially square shape.

15. The ladle of claim 14, wherein the handle defines five distinct portions adapted to provide adequate reach and depth for applying fluid material, carried by the ladle, to a food item.

16. A spreader for spreading fluid material on a food item, the spreader comprising:
a handle; and
a bowl having a shape substantially corresponding to a shape of the food item.

17. The spreader of claim 16, wherein the bowl defines at least one substantially straight edge.

18. The spreader of claim 16, wherein the shape is substantially square, substantially rectangular, or substantially triangular.

19. A spreader of claim 16, adapted to be nested together with other substantially identical spreaders in a substantially compact configuration.
